(19) United States
(12) Patent Application Publication
(10) Pub. No.: US 2007/0295152 A1
(43) Pub. Date: Dec. 27, 2007

(54) Vehicle steering assembly

(76) Inventor: Emerson Fittipaldi, Key Biscayne, FL (US)

Correspondence Address: MALLOY & MALLOY, P.A., 2800 S.W. Third Avenue, Historic Coral Way, Miami, FL, 33129, US

(21) Appl. No.: 11/435,157

(22) Filed: May 16, 2006

(51) Int. Cl. B62D 1/04; G05G 1/10

(52) U.S. Cl. 74/552

(57) ABSTRACT

A steering assembly for a vehicle such as, but not limited to, a motorized vehicle and including a steering frame having a base and two grip portions oppositely disposed to one another. Each of the grip portions including a hand receiving portion disposed and configured to receive a different hand of a user. Each grip portion also includes a retaining assembly comprising at least one but preferably two, oppositely disposed retaining flanges dimensioned, configured and relatively disposed to confront opposite sides of a corresponding user's hand so as to facilitate retention of each hand on a corresponding one of the hand receiving portions in an intended manner, especially when the steering frame is being rotated for purposes of maneuvering the vehicle.

### BACKGROUND OF THE INVENTION

1. Field of the Invention

This invention is directed to a steering assembly for an automobile or other vehicle, including a steering frame having spaced apart substantially opposed grip portions. Each grip portion includes a hand receiving portion adapted to receive a different hand of the user in a location on the steering frame which facilitates effective maneuvering of the vehicle by a rotation of the steering frame. Each grip portion further includes a retention assembly facilitating the retention of the hands of the user in their intended, gripping orientation so as to assure safe maneuvering of the vehicle.

2. Description of the Related Art

The increased power and high speed operating characteristics of modern day automobiles and other motorized vehicles necessitate quick, efficient and safe maneuvering of the vehicle under a variety of different operating conditions. In addition, during production, various components or systems for automobiles must be dimensioned, configured and appropriately structured to accommodate certain mandated safety features such as, but not limited, a steering wheel mounted airbag. Also, in order to make operation of a vehicle more efficient, it is common place for different automobile manufactures to locate some finger or hand activated controls directly on the exposed surface of the steering wheel in order that the driver's attention does not have to diverted from the roadway being traveled and/or the surrounding vehicular traffic.

The importance of accurate, efficient maneuvering of a vehicle as well as the focus of the driver's attention on the operation of the vehicle is especially evident in the design and structuring of steering wheels and like structures utilized in race cars or other high performance vehicles. In this latter category of vehicles direct ratio steering or like quick reaction steering assemblies are employed, which eliminates the need for extensive rotation of the steering wheel in order to quickly and accurately maneuver the vehicle. Accordingly, whether operating conventional domestic vehicles, race cars or other land based motor vehicle, it is extremely important that the user's hands not be inadvertently diverted from their intended gripping orientation on appropriate portions of the steering wheel.

In conventional, as versus specialized or high performance automobiles, the steering assembly associated with the vehicle is such that one or more continuous rotations of the steering wheel is sometimes required to turn the vehicle in an intended direction. During such turning or like maneuvering procedure, the steering wheel is structured to at least partially and somewhat automatically return to its original position. However, during the initial rotation of the steering wheel, as well as its attempted recovery to an initial position, the hands of the user frequently become displaced from their normal, intended gripping engagement with intended peripheral portions of the steering wheel. Under such conditions such displacement at least temporarily renders the maneuverability of the vehicle out of the driver's control. Obviously, such situations are dangerous and the problems and disadvantages associated with inadvertent and sometimes prolonged removal of the driver hands from the steering wheel is recognized as a dangerous condition which should be avoided under practically all driving conditions.

Accordingly, there is a significant and long standing need for a steering assembly capable of being used with a variety of different vehicles, which overcomes the problems and disadvantages of the type set forth above. More specifically, in order to overcome such problems, a proposed steering assembly should incorporate a steering frame, steering wheel, control handle or like structure which facilitates the safe operation of the vehicle by facilitating retention of the hands of the driver in their intended gripping position relative to the steering frame, under practically all driving condition. In addition, an improved and proposed steering assembly should specifically provide structural and operative features which eliminate or significantly reduce the possibility of inadvertent removal or displacement of the hands of the user from their intended gripping orientation. As such, a proposed steering assembly should comfortably accommodate the hands of the user in predetermined locations on the steering frame. Concurrently, such a predetermined orientation of the user's hands should assure effective control of the steering frame especially, but not exclusively, when the steering wheel of frame is being rotated. As such, quick, accurate and efficient maneuvering of the vehicle will be greatly enhanced.

Moreover, a proposed steering assembly of the type described herein should demonstrate sufficient versatility so as to be adaptable for use in a variety of different vehicles including conventional domestic or commercial automobiles, trucks, as well as the more high performance sport or racing vehicle. Also, the overall structure, dimension and configuration of a steering frame of an improved and proposed steering assembly should be capable of accommodating mandated safety features, as well as optional control features currently incorporated into conventional steering wheel structures of present day vehicles.

### SUMMARY OF THE INVENTION

The present invention is directed to a steering assembly for motorized, land based vehicles such as automobiles of various types and categories, as well as other motor vehicles. The steering assembly includes a steering frame which may or may not have a continuous, closed peripheral configuration of the type commonly associated with known “steering wheels”. In conventional fashion, the steering assembly of the present invention is operatively connected to the various components or mechanical linkage associated with the wheel base and/or drive train of the vehicle in order to accomplish effective maneuverability of the vehicle.

As explained in greater detail hereinafter, the frame of the steering assembly of the present invention is specifically structured to facilitate gripping thereof by the hands of the vehicle operator. Moreover, the steering frame of the present invention facilitates the proper disposition and gripping orientation of each of the hands of the user in a manner which eliminates or significantly reduces the possibility of inadvertent displacement of the user's hands from their intended location and/or orientation. It is recognized that the retention of the user's hands especially, but not exclusively, when the steering frame is being rotated to accomplish an intended maneuvering of the vehicle, is of particular importance.

More specifically, various preferred embodiments of the steering frame of the present invention include a base or boss being centrally disposed relative to the periphery of the frame. In addition, two grip portions are connected to or define a portion of the frame and are located in spaced, substantially oppositely disposed relation to one another, such as on opposite sides of the steering frame. Further, each of the grip portions includes a hand receiving portion which is dimensioned and configured to receive a different hand of the user. Also, each of the hand receiving portions are adapted to accommodate a predetermined orientation of a corresponding hand, in what may be generally referred to as a gripping orientation, about the steering frame.

While intended to provide sufficient comfort to the vehicle operator, the aforementioned “gripping orientation” may vary for each individual operator. However, a “gripping orientation” is intended to generally describe the fingers of the corresponding hand being disposed in at least partially surrounding relation to the corresponding gripping portion, while a palm area of the user's hand concurrently overlies a frontal or exposed surface of each hand receiving portion. Additional structural features associated with each of the hand receiving portions may include a plurality of finger recesses appropriately disposed, configured and dimensioned to receive the individual fingers of a corresponding hand, so as to further facilitate the aforementioned gripping orientation.

Also, each of the hand receiving portions includes a thumb recess primarily disposed on an inner area of each of the grip portions. The plurality of finger recesses and the thumb recess associated with each of the grip portions are such as to effectively separate the thumb from the other plurality of fingers while facilitating the gripping orientation of the hand. As such, the hand is comfortably but effectively disposed in its intended, gripping orientation and at a predetermined location on the steering frame.

Yet another feature of the present invention is the provision of a retaining assembly on each of the aforementioned gripping portions of the steering frame. Moreover, at least one preferred embodiment of the steering assembly of the present invention comprises the retaining assembly including at least one, but preferably two oppositely disposed retaining members. The retaining members of each of the retaining assemblies are connected to the corresponding grip portion, at opposite ends of the hand receiving portion. As such, each of the oppositely disposed retaining members of a corresponding grip portion is disposed, dimensioned and configured to confront opposite sides of a corresponding hand of the user. Such confrontational relation between corresponding retaining members and the hands of the user serves to eliminate or significantly reduce the possibility of the user's hands becoming inadvertently and/or forcibly displaced from their intended gripping orientation relative to the steering frame.

As is well recognized in both conventional and high speed driving, significant forces are placed on the steering frame or steering wheel when it is rotated in an attempt to turn or otherwise maneuver the automobile. Forces to which the steering frame or wheel are subjected may increase at high speeds or under driving conditions associated with rough roads, etc. In order to avoid slippage of the user's hands relative to the steering frame or complete displacement thereof, the retaining members are disposed in confronting relation with the opposite sides of a corresponding the hand when it is in its intended gripping orientation. Therefore, it is significantly easier for the driver to maintain the intended gripping orientation of the steering frame, even while rotating the steering frame, regardless of the attitude or orientation of the steering frame during the intended or required maneuvering of the vehicle. For purposes of clarity the “opposite sides” of the each of the users hands may be defined by longitudinal peripheral portions of the hand such as associated with the thumb and index finger, as one side of the user's hand, and the oppositely disposed small finger of the user's hand adjacent the open side of the palm.

The steering assembly of the present invention thereby incorporates an improved steering frame having structural and operative features which provides for efficient, quick and safe maneuverability of various a vehicle on which the steering assembly and attendant steering frame is utilized. Such structural and operative features further serve to overcome problems and disadvantages associated with known or conventional steering apparatus of the type typically associated with automobiles or other vehicles, as well as various types of steering or control apparatus or devices associated with vehicles of all types.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a front perspective view of the steering assembly of the present invention comprising a steering frame with oppositely disposed gripped portions associated therewith.

FIG. 2 is a perspective view in partial cutaway of one grip portion of the preferred embodiment of FIG. 1, adapted to accommodate a left hand of a vehicle operator.

FIG. 3 is a perspective view in partial cutaway of one grip portion associated with the preferred embodiment of FIG. 1, adapted to accommodate a right hand of a vehicle operator.

FIG. 4 is another perspective view in partial cutaway of one grip portion of the preferred embodiment of FIG. 1, adapted to accommodate a left hand of a vehicle operator.

FIG. 5 is yet another perspective view in partial cutaway of one grip portion of the preferred embodiment of FIG. 1, adapted to accommodate a right hand of a vehicle operator.

FIG. 6 is yet another perspective view in detail and partial cutaway of one grip portion of the preferred embodiment of FIG. 1, adapted to accommodate a right hand of a vehicle operator.

FIG. 7 is yet another perspective view in detail and partial cutaway of one grip portion of the preferred embodiment of FIG. 1, adapted to accommodate a right hand of a vehicle operator.

Like reference numerals refer to like parts throughout the several views of the drawings.

### DETAILED DESCRIPTION OF THE PREFERRED EMBODIMENT

As represented in the accompanying drawings, the present invention is directed to a steering assembly generally indicated as 10 for a motorized vehicle such as, but not limited to, an automobile. The steering assembly 10 includes a steering frame generally indicated as 12 which, in at least one preferred embodiment, includes a substantially closed, continuous peripheral configuration. Moreover, the continuous peripheral configuration of the steering frame 12 comprises oppositely disposed peripheral segments 14 and 16 and oppositely disposed spaced apart grip portions 18 and 20. In addition, the steering frame 12 comprises a substantially centrally disposed boss or base generally indicated as 22 interconnected to one or more of the peripheral segments 16 and/or 14 by means of outwardly extending, interconnecting brace members 23 and 24. In addition, the base 22 is connected to the grip portions 18 and 20 by transverse brace members 26 and 28. As such, the grip portions 18 and 20 are connected to opposite sides of the base 22 and extend outwardly there from so as to be disposed at or substantially define opposite sides or ends of the steering frame 12.

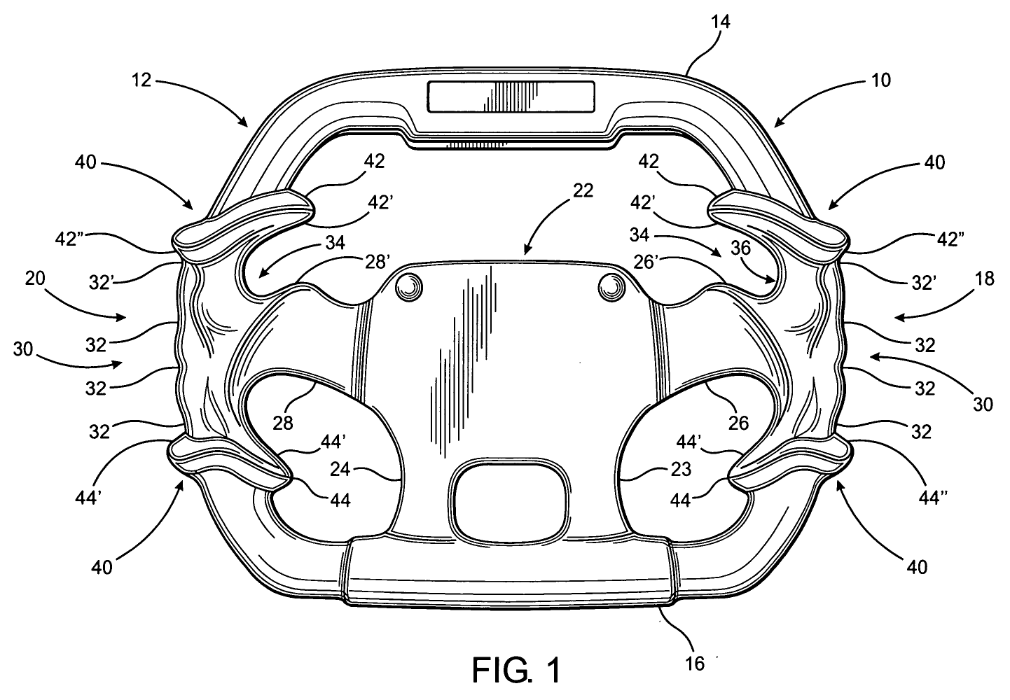

It is emphasized that while one preferred embodiment of the steering assembly 10 includes a steering frame 12 having a continuous or closed configuration as represented in FIG. 1, the important structural and operative features of the present invention can be incorporated in a steering frame which is absent such a closed, continuous peripheral configuration. Accordingly, in such an additional preferred embodiment one or both the peripheral segments 14 and 16 may not be included in the structure of the steering frame. As such, interconnecting brace members 23 and 24 may also be absent. However, when the steering frame 12 does not include a continuous or closed peripheral configuration, the grip portions 18 and 20 may be connected to the base 22. Support of the grip portions 18 and 20 could be by means of the bracing members 26 and 28 as set forth above. Accordingly, the grip portions extend outwardly from opposite sides or ends of the base 22 in spaced, substantially opposing relation to one another, as clearly demonstrated in FIG. 1.

In describing the grip portions 18 and 20, a most preferred embodiment of the steering assembly 10 includes various structural components or features of the grip portions 18 and 20 having substantially equivalent features but which are effectively “reversed” from one another. Therefore, it is accurate to describe the grip portions 18 and 20 as being dimensioned, configured and comprising an overall structure which is adapted to receive and accommodate a different hand of a user. When in the position or orientation represented in FIG. 1, grip portion 18 is disposed and structured to accommodate a right hand of a user in a predetermined gripping orientation as will be described in greater detail hereinafter. In contrast, the grip portion 20 of the embodiment of FIG. 1 is structured to accommodate the left hand of a user or operator of the vehicle in a preferred gripping orientation.

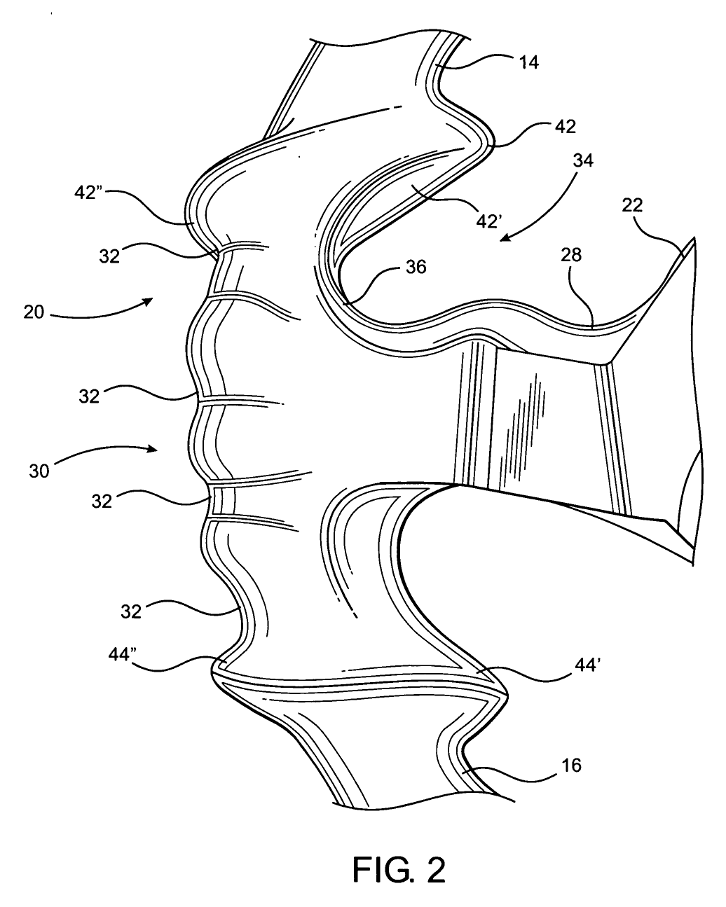

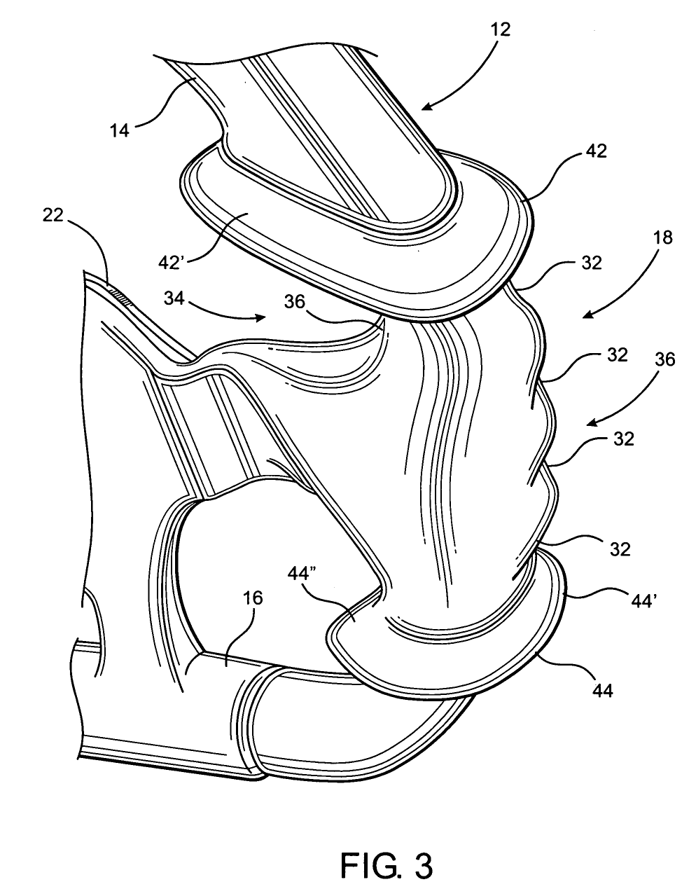

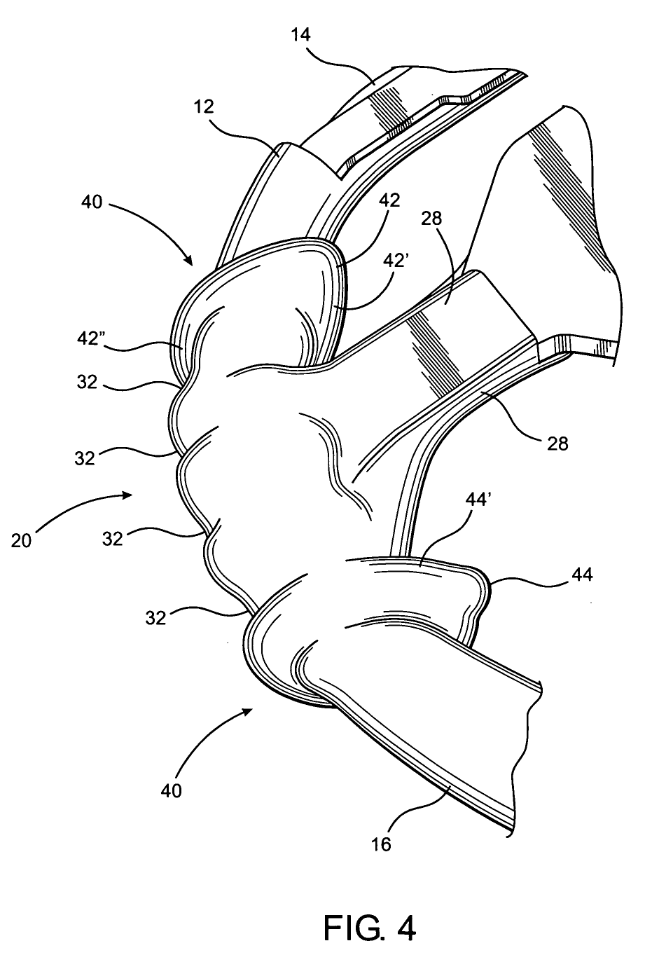

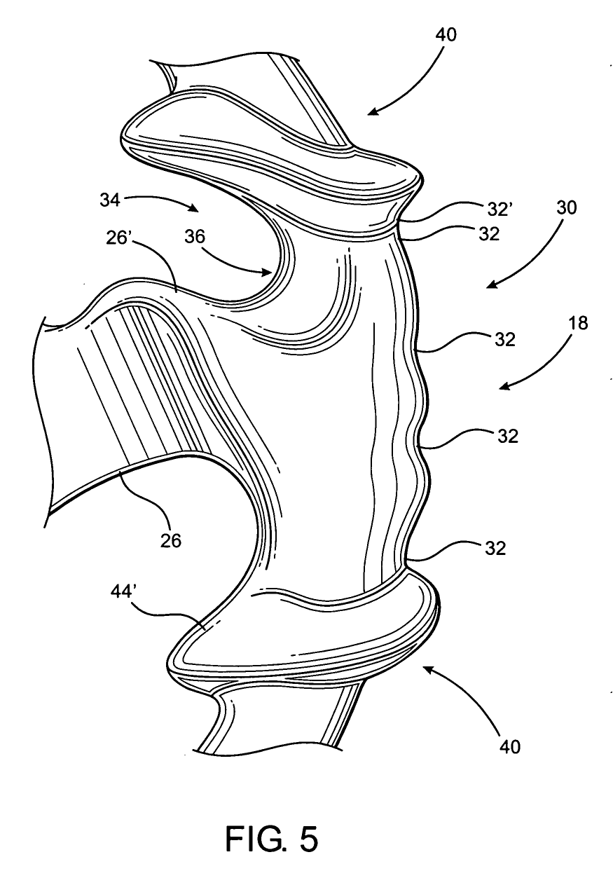

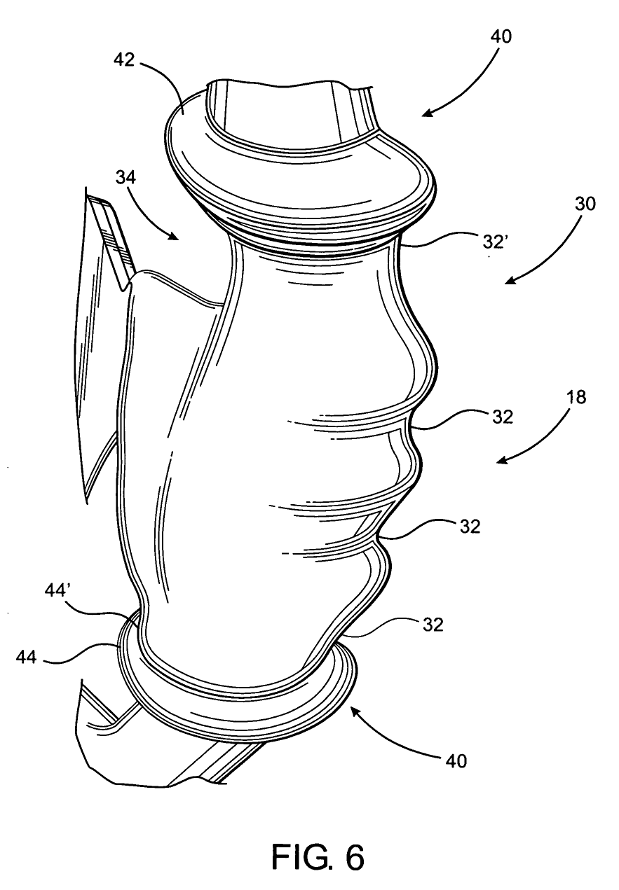

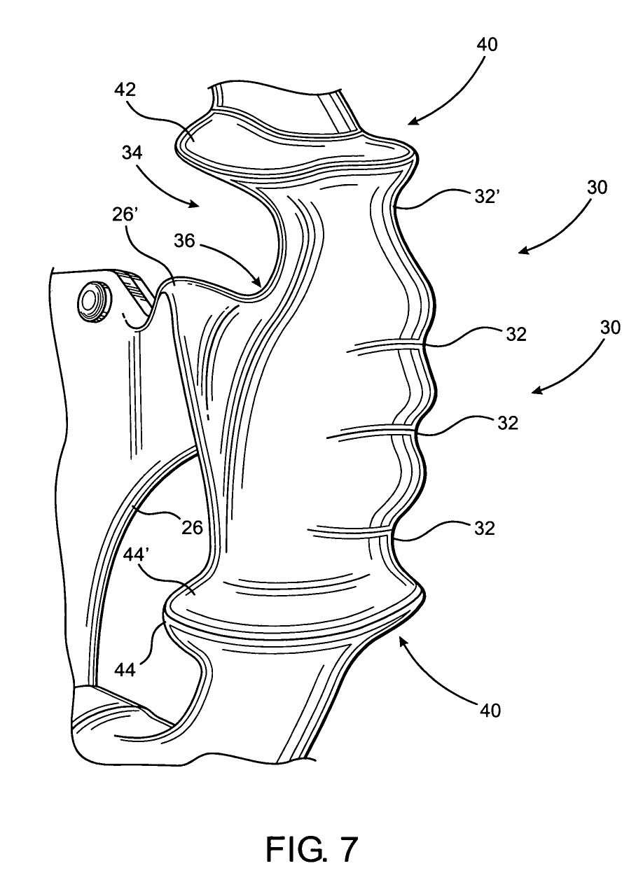

Additional structural features of each of the grip portions 18 and 20 include a hand receiving portion 30 dimensioned and configured to comfortably receive a corresponding hand of the vehicle operator. More precisely, each of the hand receiving portions 30 facilitates the orientation of the corresponding hand in gripping engagement with the steering frame 12. Such a gripping engagement comprises the thumb and fingers of each hand substantially surrounding respective ones of the grip portions 18 and 20. Moreover, orientation of the hand of the operator in gripping engagement with the steering frame 12 is further facilitated through the provision of at least one but preferably a plurality of finger recesses 32. The finger recesses are disposed on and extend at least partially about the side surface and/or under surface of the respective grip portions 18 and 20 as generally represented in FIG. 1 and as more specifically represented in FIGS. 2 through 7. Further, the plurality of finger recesses 32 are successively disposed relative to the length of each hand receiving portion 30 and are preferably four in number to accommodate the four fingers of the corresponding hand of the vehicle operator. However, it is emphasized that a lesser number of finger recesses 32 may be provided on each of the grip portions 18 and 20 in order to better facilitate or otherwise customize the configuration of the grip portions 18 and 20 to accommodate the size and shape of the hands of different individuals. In addition, when the steering assembly 10 of the present invention is used on a race car or other high performance vehicle, the specific dimensions and configurations of the grip portions 18 and 20, including the shape and number of finger recesses 32 may be customized to accommodate individual drivers.

Yet another feature of each of the grip portions 18 and 20 and their corresponding hand receiving portions 30 is the provision of a thumb recess generally indicated as 34 disposed substantially adjacent or in corresponding relation to one end of the hand receiving portion 30. The location of the thumb recess corresponds to the location of the thumb on an operators hand when that hand is in a gripping orientation about the respective grip portions 18 and 20. Moreover, each of the thumb recesses 34 includes an elongated channel as at 36 extending along and integrally formed in outer and at least partially inner surface portions of each hand receiving portion 30. Each channel 36 has a sufficient length to support or at least engage a significant length of the thumb of the operator, when the thumb is appropriately positioned within the corresponding thumb recesses 34. Also, the width of the elongated channel 36 of each of the thumb recesses 34 is such as to extend along or at least partially define an outer end of each of the brace segments 26 and 28, as at 26′ and 28′. Accordingly, the configuration, and dimension of each of the channels 36 of the respective thumb recesses 34 serve to engage, at least partially support as well as facilitate a preferred orientation of the operator's thumbs. It is further emphasized that the cooperative disposition and overall structure of the thumb recess 34 relative to the one or more finger recesses 32 further facilitates the intended orientation of the operator's hand in gripping, at least partially surrounding relation to the respective grip portions 18 and 20.

Yet another feature of a most preferred embodiment of the steering frame 12 of the steering assembly 10 includes each of the grip portions 18 and 20 comprising a retaining assembly generally indicated as 40. As will be described in greater detail hereinafter, each retaining assembly 40 is cooperatively structured with the remainder of the corresponding grip portions 18 and 20 and hand receiving portions 30 such that the corresponding hands of the operator are effectively retained in the intended gripping orientation relative to the grip portions 18 and 20. Such intended retention of the hands of the operator eliminates or significantly reduces the possibility of inadvertent or forced displacement of the hands from the gripping portions 18 and 20, especially when the steering frame 12 is being rotated to maneuver the vehicle on which the steering assembly 10 is mounted.

Accordingly, the retaining assembly 40 includes at least one but more practically two spaced apart retaining members or flanges 42 and 44 each located at a different opposite end of each hand receiving portion 30 of each of the grip portions 18 and 20. Moreover, each of the retaining flanges 42 and 44 may assume a generally ergonomically configured structure to facilitate disposition thereof in engaging or at least confronting relation to the opposite sides of a corresponding hand of the user. Further, each of the retaining members or flanges 42 and 44 extend transversely outward from the remainder of the steering frame 12. The transverse dimension and overall configuration of the retaining members or flanges 42 is also sufficient to extend transversely outward from the hand or receiving portions 30.

With reference to each of the retaining members or flanges 42 represented in the various Figures, the under surface thereof as at 42′ is specifically disposed and cooperatively configured in contiguous relation with the thumb recesses 34 so as to define a part thereof. This contiguous relation serves to guide or otherwise direct the thumbs of the operator into the preferred gripping orientation with the grip portions 18 and 20. Similarly, the outer, under surface of the retaining members or flanges 42 as at 42″ is such as to engage or at least direct the index finger of the corresponding hand into an appropriate finger recess 32′, thereby further facilitating proper orientation of the hand about the grip portions 18 and 20 and relative to the hand receiving portions 30. Similarly, the retaining members or flanges 44 have an inner and outer surface 44′ and 44″ disposed and configured to engage or at least confront corresponding hands of the user to assume a preferred orientation thereof relative to the grip portions 18 and 20.

Accordingly, the steering assembly 10 of the present invention is structured for use on a variety of different motor vehicles primarily including, but not limited to, a plurality of different categories of automobiles. Also, the overall, structural and operative features of the steering frame 12, including the oppositely disposed grip portions 18 and 20, the hand receiving portions 30 and the retaining assembly 40 associated therewith serve to overcome many of the recognized problems and disadvantages associated with substantially conventional steering structures known and used on modern day vehicles.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A steering assembly comprising:
a frame including a base,
two grip portions connected to said base and extending outwardly therefrom,
each of said grip portions including a hand receiving portion disposed and configured to receive a different hand of a user,
each of said grip portions further including a retaining assembly comprising at least one retaining member disposed at one end of said hand receiving portion, and
each of said retaining members dimensioned and configured to retain the user's hand on a corresponding one of said grip portions.

2. A steering assembly as recited in claim 1 wherein each of said grip portions comprises two retaining members disposed at opposite ends of a corresponding one of said hand receiving portions.

3. A steering assembly as recited in claim 2 wherein each of said two retaining members of each of said grip portions is dimensioned and configured to retain the user's hand on a corresponding one of said grip portions.

4. A steering assembly as recited in claim 1 wherein said two grip portions extend outwardly from opposite sides of said base and are disposed to define substantially opposite peripheral portions of said frame.

5. A steering assembly as recited in claim 4 wherein said two grip portions are disposed and cooperatively configured with a remainder of said frame to at least partially defined opposite sides of said frame.

6. A steering assembly as recited in claim 4 wherein said frame comprises a substantially elongated configuration; said two grip portions disposed at opposite ends of said frame.

7. A steering assembly as recited in claim 1 wherein each of said two hand receiving portions further comprises a thumb recess disposed and configured to support a thumb of a user in at least partially surrounding relation to said grip portion.

8. A steering assembly as recited in claim 7 wherein each of said thumb recesses comprises an elongated channel disposed and dimensioned to engage a length of said thumb.

9. A steering assembly as recited in claim 7 wherein each of said thumb recesses is disposed at one end of a corresponding one of said hand receiving portions and adjacent said one retaining member.

10. A steering assembly as recited in claim 9 wherein at least a portion of each of said thumb recesses is disposed contiguous to an inner surface of a corresponding one of said retaining members.

11. A steering assembly as recited in claim 10 wherein each of said hand receiving portions comprises a plurality of finger recesses disposed on an exterior surface of a corresponding one of said grip portions.

12. A steering assembly as recited in claim 7 wherein each of said hand receiving portions comprises a plurality of finger recesses disposed on an exterior surface of a corresponding one of said grip portions.

13. A steering assembly as recited in claim 1 wherein said frame further includes oppositely disposed peripheral segments each disposed in interconnecting relation to corresponding opposite ends of said grip portions.

14. A steering assembly as recited in claim 13 wherein said peripheral segments and said grip portions collectively comprise a closed, continuous periphery of said frame.

15. A steering assembly for a vehicle comprising:
a frame,
two grip portions substantially oppositely disposed on said frame,
each of said grip portions including a hand receiving portion configured to accommodate a different hand of a user,
a retaining assembly disposed on each of said grip portions substantially at opposite ends of a corresponding one of said hand receiving portions, and
each of said retainining assemblies dimensioned and configured to retain a corresponding hand in gripping engagement with a corresponding one of said hand receiving portions.

16. A steering assembly as recited in claim 15 wherein each of said retaining assemblies is disposed in confronting relation to opposite sides of the corresponding hand when in a gripping orientation relative to said corresponding hand receiving portion.

17. A steering assembly as recited in claim 15 wherein each of said two hand receiving portions further comprises a thumb recess disposed and configured to support a thumb of a user in at least partially surrounding relation to said grip portion.

18. A steering assembly as recited in claim 17 wherein each of said thumb recesses comprises an elongated channel disposed and dimensioned to engage a length of said thumb.

19. A steering assembly as recited in claim 15 wherein each of said retaining assemblies comprises two flanges each disposed at a different opposite end of said hand receiving portion.

20. A steering assembly as recited in claim 19 wherein said two flanges of each of said grip portions extends transversely outward from a corresponding one of said hand receiving portions.

21. A steering assembly as recited in claim 20 wherein said two flanges of each of said grip portions comprise an inner surface configured to at least partially adapt to a correspondingly positioned side of a user's hand and disposed in confronting relation thereto.

22. A steering assembly as recited in claim 19 wherein each of said grip portions comprises a thumb recess disposed at one end of a corresponding one of said hand receiving portions and adjacent one of said retaining members, said thumb recess configured to support a thumb of a user in at least partially surrounding relation to said grip portion.

23. A steering assembly as recited in claim 22 wherein each of said thumb recesses comprises an elongated channel disposed and dimensioned to engage a length of said thumb.

24. A steering assembly as recited in claim 22 wherein at least a portion of each of said thumb recesses is disposed contiguous to an inner surface of a corresponding one of said retaining members.

25. A steering assembly as recited in claim 22 wherein each of said hand receiving portions comprises a plurality of finger recesses disposed on an exterior surface of a corresponding one of said grip portions.

26. A steering assembly for a vehicle comprising:
a frame including a centrally disposed base,
two grip portions substantially oppositely disposed on said frame,
each of said grip portions including a hand receiving portion configured to accommodate a different hand of a user,
a retaining assembly comprising two flanges disposed on each of said hand receiving portions, each of said flanges disposed at a different opposite end of said hand receiving portion,
each of said two flanges of each of said grip portions comprising an inner surface configured to at least partially adapt to a correspondingly positioned side of a use's hand and disposed in confronting relation therewith,
wherein each of said grip portions comprises a thumb recess disposed at one end of a corresponding one of said hand receiving portions and adjacent one of said retaining members, said thumb recess configured to support a thumb of a user in at least partially surrounding relation to said grip portion, and
at least a portion of each of said thumb recesses being disposed contiguous to an inner surface of a corresponding one of said retaining members.

27. A steering assembly as recited in claim 26 wherein said frame further includes oppositely disposed peripheral segments each disposed in interconnecting relation to correspondingly disposed opposite ends of said grip portions; said peripheral segments and said grip portion collectively defining a closed, continuous periphery of said frame.
